(19) United States
(12) Patent Application Publication
(10) Pub. No.: US 2024/0109715 A1
(43) Pub. Date: Apr. 4, 2024

(54) Pressure storage type spray pump and pressure storage type spray device

(71) Applicant: ZHONGSHAN SHINNOV PACKAGING TECHNOLOGY CO., LTD., Zhongshan (CN)

(72) Inventor: Zhiqiang SHI, Zhongshan (CN)

(21) Appl. No.: 18/534,774

(22) Filed: Dec. 11, 2023

Related U.S. Application Data
(63) Continuation of application No. PCT/CN2021/132053, filed on Nov. 22, 2021.

(30) Foreign Application Priority Data
Jun. 11, 2021 (CN) 202110654457.4

(51) Int. Cl. B65D 83/28; B65D 83/32; B65D 83/40; B65D 83/48

(52) U.S. Cl. CPC B65D 83/28; B65D 83/32; B65D 83/40; B65D 83/48

(57) ABSTRACT

A pressure storage type spray pump is provided, which is capable of achieving continuous spraying with a simple and small structure and low cost, and has good safety performance. The spray pump includes a main column and a cylinder body, wherein a fluid channel extending in an axial direction is formed inside the main column, and the cylinder body accommodates a working liquid. The spray pump further includes a one-way valve mechanism, a storage chamber, and an upper elastic mechanism. The upper elastic mechanism displaces towards the maximum compression position when the main column is pressed, so that the storage chamber is in fluid communication with the fluid channel; and the upper elastic mechanism displaces towards the initial position when the main column is released.

### TECHNICAL FIELD

The pressure disclosure relates to a pressure storage type spray pump and a pressure storage type spray device.

### BACKGROUND

In recent years, a press type spray pump is widely used in daily life, especially in daily chemicals, skin care products, cosmetics, pharmaceuticals, and the like.

However, most of spray devices used in the existing market achieve spraying discontinuously. The spray device achieves spraying once per press. Therefore, in a case of spraying for multiple times, the operation is cumbersome. In addition, at the beginning and end of each spray, there will be fog drops with poor atomization effect falling from a nozzle.

Therefore, frequent pressing will cause waste of products. For this reason, two continuous spray technologies have been proposed at present. One continuous spray technology is the Flair® technology developed by the AFA Dispnsing Group (for example, the international publication WO2012-061764A1), which can achieve continuous spraying. The other continuous spray technology is to achieve continuous spraying by using aerosol (gaseous propellant).

### LITERATURE OF THE PRIOR ART

### Patent Literature

Patent literature 1: International Publication WO2012-061764A1

### SUMMARY

### Technical Problem to be Solved in the Present Disclosure

However, in a case of using the Flair® technology, an internal structure of a spray pump will become complex, and a volume of the spray pump will become large, which will lead to high production cost and high price of the spray pump.

On the other hand, in a case of using aerosol to achieve continuous spraying, since the aerosol usually contains organic alkane gas serving as a gaseous propellant, a spray device using this technology has potential safety hazard and high production and manufacturing cost.

The present disclosure is formed to solve the above technical problems, and aims to provide a pressure storage type spray pump and a pressure storage type spray device, which are capable of achieving continuous spraying with a simple and small structure and low cost, and has good safety performance.

### Technical Solutions Adopted to Solve the Technical Problems

A pressure storage type spray pump according to a first point of view of the present disclosure includes a main column and a cylinder body, wherein a fluid channel extending in an axial direction is formed inside the main column, and the cylinder body accommodates a working liquid and is inserted with the main column;
the spray pump further includes a one-way valve mechanism, a storage chamber, and an upper elastic mechanism which are axially arranged between the main column and the cylinder body;
the storage chamber is formed between the one-way valve mechanism and the upper elastic mechanism;
the one-way valve mechanism is configured to be opened only when the main column is pressed and only allow the working liquid to flow from the cylinder body into the storage chamber;
the upper elastic mechanism is configured to be capable of displacing, relative to the main column, between an initial position and a maximum compression position; the upper elastic mechanism displaces towards the maximum compression position when the main column is pressed, so that the storage chamber is in fluid communication with the fluid channel; and the upper elastic mechanism displaces towards the initial position when the main column is released.

Based on the pressure storage type spray pump according to the first point of view of the present disclosure, in the pressure storage type spray pump according to a second point of view of the present disclosure, preferably,
the one-way valve mechanism includes:
a second piston, wherein the second piston and the upper elastic mechanism are arranged in the axial direction through the storage chamber and are fixed to the main column, and a through hole that penetrates through the second piston in the axial direction is formed in the second piston;
a second elastic body, wherein the elastic body is connected to the main column and the cylinder body in the axial direction, or is connected to the second piston and the cylinder body in the axial direction; and
an elastic separator member, wherein the elastic separator member is configured to cover the through hole; and
by pressing the main column, the elastic separator member deforms to open the through hole.

Based on the pressure storage type spray pump according to the second point of view of the present disclosure, in the pressure storage type spray pump according to a third point of view of the present disclosure, preferably, a plurality of through holes are circumferentially formed at equal intervals in the second piston.

Based on the pressure storage type spray pump according to the first point of view of the present disclosure, in the pressure storage type spray pump according to a fourth point of view of the present disclosure, preferably,
the one-way valve mechanism includes:
an annular second piston, wherein the second piston and the upper elastic mechanism are arranged in the axial direction through the storage chamber; and
a second spring, wherein the second spring is connected to the main column and the cylinder body in the axial direction;
a groove extending in the axial direction is formed in an inner surface of the second piston; and
an annular flange protruding towards a radial inner side is formed at one end of the second piston away from the storage chamber, and the annular flange seamlessly and tightly abuts against an outer surface of the main column in a radial direction of the main column; and
by pressing the main column, the annular flange is separated from the outer surface of the main column, and the cylinder body is in fluid communication with the storage chamber through the groove.

Based on the pressure storage type spray pump according to the fourth point of view of the present disclosure, in the pressure storage type spray pump according to a fifth point of view of the present disclosure, preferably, a plurality of the grooves are circumferentially formed at equal intervals in the inner surface of the second piston.

Based on the pressure storage type spray pump according to the first point of view of the present disclosure, in the pressure storage type spray pump according to a sixth point of view of the present disclosure, preferably,
the one-way valve mechanism includes:
an annular second piston, wherein the second piston and the upper elastic mechanism are arranged in the axial direction through the storage chamber;
an auxiliary column, wherein the auxiliary column is fixedly connected to one end portion of the main column close to the second piston, and the auxiliary column seamlessly and tightly abuts against the second piston in the axial direction; and
a second spring, wherein the second spring is connected to the auxiliary column and the cylinder body in the axial direction;
a groove extending in the axial direction is formed in an inner surface of the second piston; and
by pressing the main column, the second piston is separated from the auxiliary column, and the cylinder body is in fluid communication with the storage chamber through the groove.

Based on the pressure storage type spray pump according to the sixth point of view of the present disclosure, in the pressure storage type spray pump according to a seventh point of view of the present disclosure, preferably, a plurality of the grooves are circumferentially formed at equal intervals in the inner surface of the second piston.

Based on the pressure storage type spray pump according to any one of the first point of view to the seventh point of view of the present disclosure, in the pressure storage type spray pump according to an eighth point of view of the present disclosure, preferably,
a fine hole communicated with the fluid channel is formed in a side wall of the main column;
when the upper elastic mechanism is at the initial position, the fine hole is closed by the upper elastic mechanism; and
by pressing the main column, the fine hole is opened, so that the storage chamber is in fluid communication with the fluid channel.

Based on the pressure storage type spray pump according to the eighth point of view of the present disclosure, in the pressure storage type spray pump according to a ninth point of view of the present disclosure, preferably, a plurality of fine holes are circumferentially formed at equal intervals on the side wall of the main column.

Based on the pressure storage type spray pump according to any one of the second point of view to the seventh point of view of the present disclosure, in the pressure storage type spray pump according to a tenth point of view of the present disclosure, preferably, a stop portion is formed on one surface of the second piston close to the upper elastic mechanism, and the stop portion is configured to receive the upper elastic mechanism and cause the upper elastic mechanism to be located at the initial position.

Based on the pressure storage type spray pump according to any one of the second point of view to the eighth point of view of the present disclosure, in the pressure storage type spray pump according to an eleventh point of view to a thirteenth point of view of the present disclosure, preferably,
the upper elastic mechanism includes:
a first piston, wherein the first piston is arranged between the main column and the cylinder body, and the first piston and the second piston face each other in the axial direction through the storage chamber; and
a first elastic body, wherein the first elastic body is connected to the main column and the first piston in the axial direction.

A pressure storage type spray device according to a fourteenth point of view of the present disclosure includes:
the pressures storage type spray pump according to any one of the first point of view to the thirteenth point of view; and
a press type sprayer, wherein the press type sprayer cooperates with the pressure storage type spray pump to apply a force to the main column of the pressure storage type spray pump in the axial direction.

Based on the pressure storage type spray device according to the fourteenth point of view of the present disclosure, in the pressure storage type spray device according to a fifteenth point of view of the present disclosure, preferably, the pressure storage type spray device further includes a cover component, wherein the cover component is configured to accommodate the cylinder body inserted with the main column.

Based on the pressure storage type spray device according to the fifteenth point of view of the present disclosure, in the pressure storage type spray pump according to a sixteenth point of view of the present disclosure, preferably, the cover component is a screw cap with a thread on an inner wall.

### Beneficial Effects

According to the present disclosure, the pressure storage type spray pump and the pressure storage type spray device can be provided, which can achieve continuous and ceaseless spraying with a simple and small structure and low cost, and has good safety performance. In addition, the present disclosure can achieve continuous and ceaseless spraying, so that the working fluid can be uniformly sprayed to a target.

### BRIEF DESCRIPTION OF THE DRAWINGS

FIG. 1 is a three-dimensional diagram of a pressure storage type spray device including a pressure storage type spray pump according to a first implementation of the present disclosure.

FIG. 2 is a three-dimensional diagram of a pressure storage type spray pump according to a first implementation of the present disclosure.

FIG. 3 is a sectional view of a pressure storage type spray pump according to a first implementation of the present disclosure, showing an internal structure of the pressure storage type spray pump in an initial state.

FIG. 4A is a three-dimensional diagram of a second piston that constitutes a pressure storage type spray pump according to a first implementation of the present disclosure.

FIG. 4B is a sectional view of the second piston of FIG. 4A.

FIG. 5A is a three-dimensional diagram of an elastic separator member that constitutes a pressure storage type spray pump according to a first implementation of the present disclosure.

FIG. 5B is a sectional view of the elastic separator member of FIG. 4A.

FIG. 6 is a sectional view of a pressure storage type spray pump in a pressed state according to a first implementation of the present disclosure.

FIG. 7 is a sectional view of a pressure storage type spray pump in a released state according to a first implementation of the present disclosure.

FIG. 8 is a sectional view of a pressure storage type spray pump according to a second implementation of the present disclosure, showing an internal structure of the pressure storage type spray pump in an initial state.

FIG. 9A is a three-dimensional diagram of a second piston that constitutes a pressure storage type spray pump according to a second implementation of the present disclosure.

FIG. 9B is a sectional view of the second piston of FIG. 9A.

FIG. 10 is a sectional view of a pressure storage type spray pump in a pressed state according to a second implementation of the present disclosure.

FIG. 11 is a sectional view of a pressure storage type spray pump in a released state according to a second implementation of the present disclosure.

FIG. 12 is a sectional view of a pressure storage type spray pump according to a third implementation of the present disclosure, showing an internal structure of the pressure storage type spray pump in an initial state.

FIG. 13A is a three-dimensional diagram of a second piston that constitutes a pressure storage type spray pump according to a third implementation of the present disclosure.

FIG. 13B is a sectional view of the second piston of FIG. 13A.

FIG. 14A is a sectional view of an auxiliary column that constitutes a pressure storage type spray pump according to a third implementation of the present disclosure.

FIG. 14B is a sectional view of the auxiliary column of FIG. 14A.

FIG. 15 is a sectional view of a pressure storage type spray pump in a pressed state according to a third implementation of the present disclosure.

FIG. 16 is a sectional view of a pressure storage type spray pump in a released state according to a third implementation of the present disclosure.

### DETAILED DESCRIPTION OF THE EMBODIMENTS

Pressure storage type spray pumps and structures of the pressure storage type spray pumps of the various implementations of the present disclosure will be described in detail below with reference to the drawings.

### First Implementation

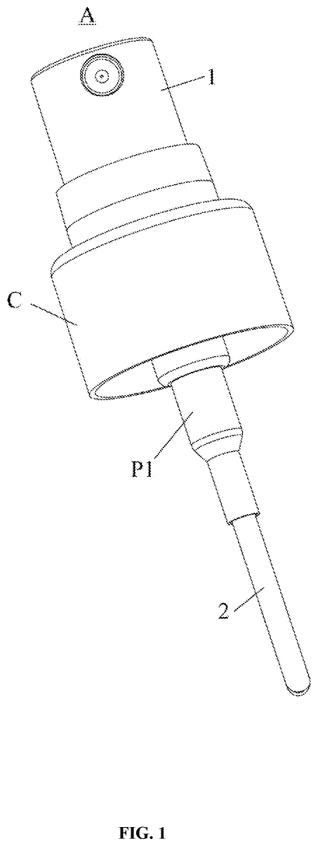

FIG. 1 shows a three-dimensional diagram of a pressure storage type spray device A including a pressure storage type spray pump P1 according to a first implementation of the present disclosure. As shown in FIG. 1, the pressure storage type spray device A includes a press type sprayer 1, a cover component C, a pressure storage type spray pump P1, and a suction pipe 2. The press type sprayer 1 can be a commercial conventional sprayer, and a user can manually press the press type sprayer 1 to perform spraying. The press type sprayer 1 is embedded in the cover component C, and the cover component C is a member configured to fix the pressure storage type spray device A to a bottle body (not shown). In this implementation, the cover component C is a screw cap with a thread C1 formed on an inner wall surface, and cooperates a thread of a bottle neck, so as to connect the pressure storage type spray device A to the bottle body to be used. In addition, the cover component C is used for arranging the pressure storage type spray pump P1 inside the spray device. In addition, a lower end portion of the pressure storage type spray pump P1 is connected with a suction pipe 2. The suction pipe 2 is configured to supply a working liquid (liquid for spraying) from a bottle to an aftermentioned cylinder body 3 of the pressure storage type spray pump P1.

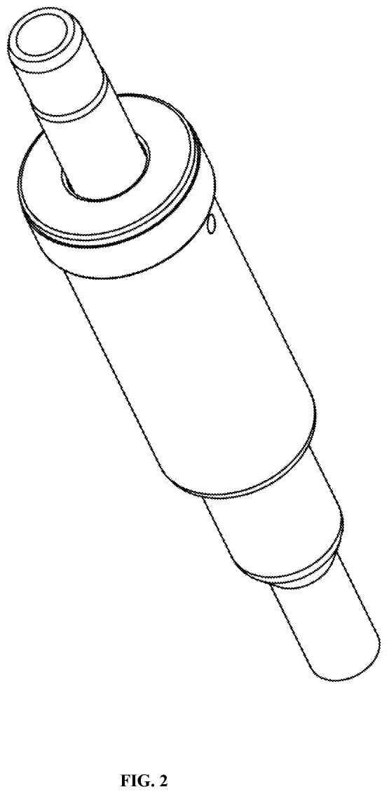

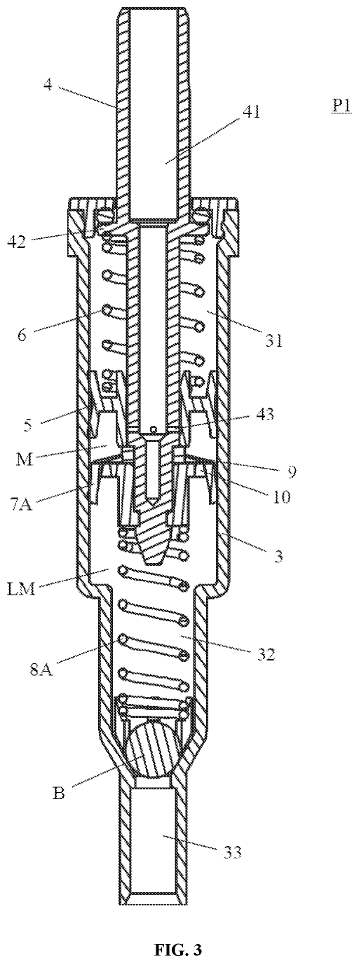

FIG. 2 shows a three-dimensional diagram of a pressure storage type spray pump P1 according to a first implementation of the present disclosure. FIG. 3 shows a sectional view of a pressure storage type spray device A including a pressure storage type spray pump P1 according to a first implementation of the present disclosure. As shown in FIG. 2 and FIG. 3, the pressure storage type spray pump P1 includes a cylinder body 3 and a main column 4. The cylinder body 3 is a cylindrical component with openings in an upper end and a lower end, which includes a large diameter portion 31, a small diameter portion 32, and a liquid inlet portion 33. The large diameter portion 31 accommodates a part of the aftermentioned main column 4, a part of an aftermentioned one-way valve mechanism, and an aftermentioned upper elastic mechanism. The small diameter portion 32 accommodates the other portion of the aftermentioned one-way valve mechanism and a steel ball B. The suction pipe 2 is inserted into the liquid inlet portion 33. In addition, as shown in FIG. 3, the cylinder body 3 is fixed to the cover component C in an embedded manner. The main column 4 is a thin cylindrical component with an open upper end and a closed lower end. As shown in FIG. 3, a fluid channel 41 for allowing air or the working fluid to flow is formed inside the main column. In addition, an annular flange portion 42 is circumferentially formed approximately at a middle part of the main column 4 in an axial direction of the main column 4, and the flange portion 42 is configured to fix an aftermentioned first spring 6 that constitutes the upper elastic mechanism of this implementation. In addition, a fine hole 43 that penetrates through a side wall of the main column 4 in a radial direction is formed at a part of the main column 4 close to a lower end portion in the axial direction of the main column 4. Air or working liquid entering and stored in an aftermentioned storage chamber M enters the fluid channel 41 through the fine hole 43, and is sprayed out at a high speed from the fluid channel 41 to the outside through the press type sprayer 1.

In order to achieve a pressure storage type spraying effect, the pressure storage type spray pump P1 also includes a first one-way valve mechanism and an upper elastic mechanism that constitute a one-way valve type pressure storage unit.

Specifically, in this implementation, as shown in FIG. 3, the upper elastic mechanism includes a first piston 5 and a first spring 6 used as an example of a first elastic member. The first piston 5 is a annular component arranged between the cylinder body 3 and the main column 4; an inner surface of the first piston 5 seamlessly and tightly abuts against an outer side surface of the main column 4 in the radial direction; and an outer surface of the first piston 5 seamlessly and tightly abuts against an inner wall surface of the cylinder body 3 in the radial direction. That is, the air or working liquid can hardly flow from a place below to a place above the first piston 5, and cannot downwards flow from the place below the first piston 5. The first spring 6 is arranged axially, with one end connected to the flange portion 42 and the other end connected to the first piston 5. Through the above method, the first piston 5 and the first spring 6 constitute the upper elastic mechanism of this implementation.

On the other hand, similarly as shown in FIG. 3, the first one-way valve mechanism includes a second piston 7A, a second spring 8A, and an elastic separator member 9.

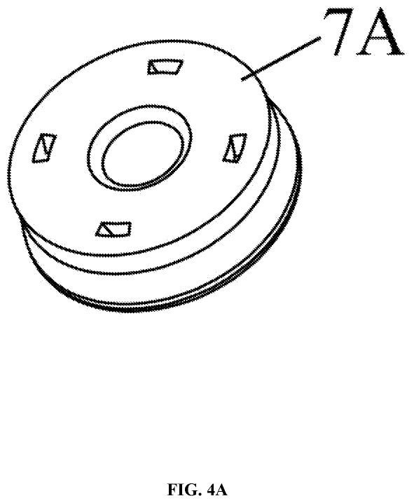

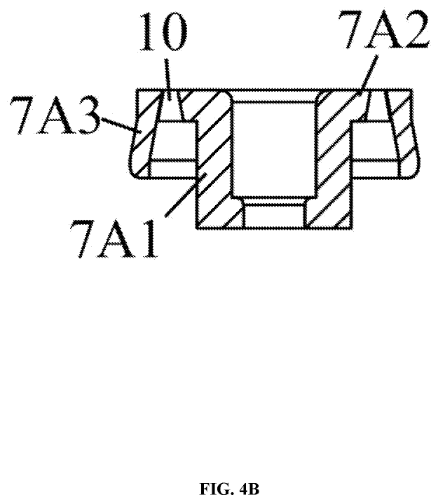

Regarding the second piston 7A, FIG. 4A shows a three-dimensional view of the second piston 7A, and FIG. 4B shows a sectional view of the second piston 7A. As shown in FIG. 3, FIG. 4A, and FIG. 4B, the second piston 7A is a roughly annular component arranged between the cylinder body 3 and the main column 4, and includes a hollow main body portion 7A1, an upper flange portion 7A2, and a side flange portion 7A3. The upper flange portion 7A2 is formed at an upper end of the main body portion 7A1 and protrudes to a radial outer side; and the side flange portion 7A3 is formed at a radial outer edge of the upper flange portion 7A2 and extends downwards in the axial direction. In a state that the second piston 7A is arranged between the cylinder body 3 and the main column 4, an inner circumferential surface of the main body portion 7A1 seamlessly and tightly abuts against the outer side surface of the main column 4 in the radial direction, and the side flange portion 7A3 seamlessly and tightly abuts against the inner wall surface of the cylinder body 3 in the radial direction. In addition, as shown in FIG. 4A and FIG. 4B, a plurality of (four) through holes 10 penetrating through the upper flange portion 7A2 in the axial direction are formed on the second piston 7A. The through holes 10 are configured to achieve fluid communication between the small diameter portion 32 of the cylinder body 3 and the aftermentioned storage chamber M. Moreover, an aperture of each through hole 10 is much larger than an aperture of each fine hole 43.

The second spring 8A is arranged in the axial direction, with one end connected to an end portion of the main column 4 and the other end connected to an end portion of the cylinder body 3.

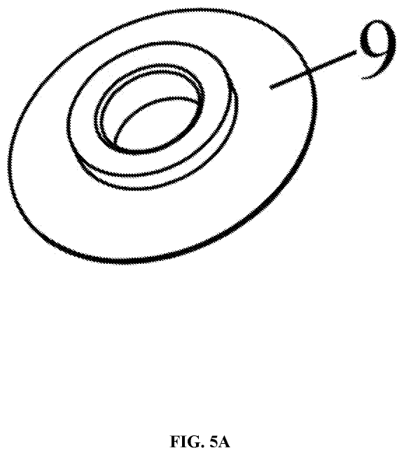

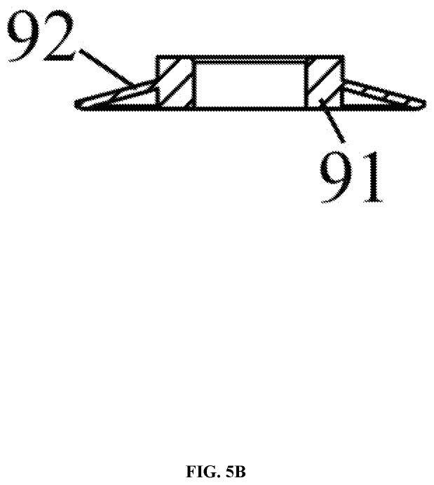

In addition, regarding the elastic separator member 9, FIG. 5A shows a three-dimensional diagram of the elastic separator member 9, and FIG. 5B shows a sectional view of the elastic separator member 9. As shown in FIG. 5A and FIG. 5B, the elastic separator member 9 is a hollow approximately disc-shaped component, which is arranged between the cylinder body 3 and the main column 4 as shown in FIG. 3 and adjacent to a place above the second piston 7A and includes a hollow columnar portion 91 and an annular plate portion 92. The annular plate portion 92 is formed along an entire outer circumferential surface of the columnar portion 91 and formed into a downward tilting shape as it moves away from the columnar portion 91 in the radial direction. The annular plate portion 92 is composed of an elastic thin plate and can have an elastic deformation in the axial direction relative to the columnar portion 91. In addition, as shown in FIG. 3, in a case that the elastic separator member 9 is arranged between the cylinder body 3 and the main column 4, the columnar portion 91 supports an upper surface of the second piston 7A (more precisely, the main body portion 7A1), and the annular plate portion 92 covers the through hole 10 from the top.

Through the above method, the second piston 7A, the second spring 8A, and the elastic separator member 9 constitute the first one-way valve mechanism of this implementation.

In addition, as shown in FIG. 3, in a case that the upper elastic mechanism and one-way valve mechanism that constitute the one-way valve type pressure storage unit of this implementation are arranged between the cylinder body 3 and the main column 4, the storage chamber M with a variable volume is formed between the cylinder body 3 and the main column 4. Specifically, as the air or working fluid flows into storage chamber M, the volume of the storage chamber M will increase. As the air or working fluid flows out of the storage chamber M, the volume of the storage chamber M will decrease. This will be explained in detail in the following text.

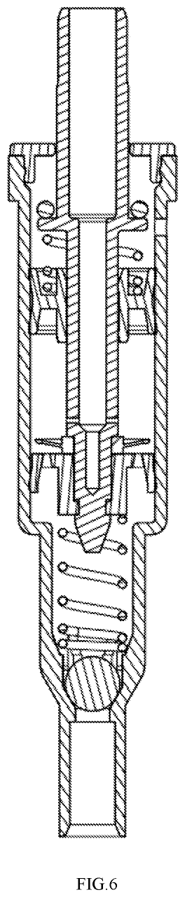

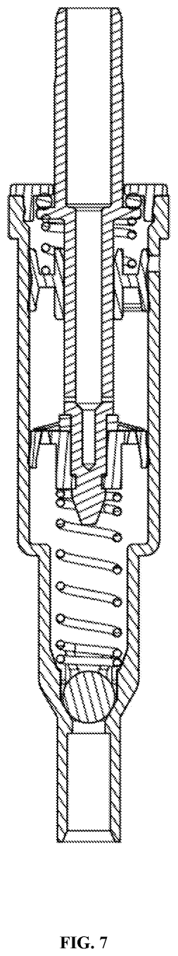

Then, based on the above structure, referring to FIG. 3, FIG. 6, and FIG. 7, the working principles of the pressure storage type spray pump P1 and the pressure storage type spray device A of this implementation will be described in detail.

FIG. 3 shows a sectional view of the pressure storage type spray pump P1 in an initial state. In the initial state, the first piston 5 is in contact with the columnar portion 91 of the elastic separator member 9 to close the fine hole 43, so that the storage chamber M and the fluid channel 41 of the main column 4 are in a disconnected state.

In a case that the pressure storage type spray pump P1 and the pressure storage type spray device A of this implementation are used for the first time, there may be air in the storage chamber M and a space (hereinafter referred to as a lower chamber LM), which is close to the second piston 7A, in the cylinder body 3. Firstly, by pressing the press type sprayer 1, the main column 4 connected to the press type sprayer 1 and the second piston 7A connected to the main column 4 move downwards in the axial direction against the second spring 8A. At this time, since the steel ball B closes a connection port between the small diameter portion 32 and the liquid inlet portion 33, the air in the lower chamber LM cannot be discharged from the bottom.

Meanwhile, since the air in the lower chamber LM is compressed, a pressure in the lower chamber LM is greater than a pressure in the storage chamber M. Therefore, as shown in FIG. 6, under the action of a pressure difference, the annular plate portion 92 of the elastic separator member 9 deforms upwards to open the through hole 10, and the air in the lower chamber LM flows into the storage chamber M. Then, as the air flows in, the first piston 5 moves upwards in the axial direction against the first spring 6. The fine hole 43 originally closed by a side surface of the first piston 5 is opened, so that the storage chamber M is in fluid communication with the fluid channel 41 in the main column 4. The air located in the storage chamber M flows into the fluid channel through the fine hole 43. However, since the aperture of the through hole 10 is much larger than the aperture of the fine hole 43, the amount of the air flowing from the lower chamber LM into the storage chamber M per unit time is greater than the amount of the air flowing from the storage chamber M into the fluid channel 41 per unit time. From the entire pressing process, the volume of the storage chamber M increases, and the first piston 5 continues to move upwards in the axial direction against the first spring 6.

When the press type sprayer 1 is pressed until the upper elastic mechanism displaces to a maximum compression position (for example, the compression deformation of the first spring 6 reaches a maximum elastic compression position or a lower end of the press type sprayer 1 resists against the cover component C), the press type sprayer 1 is released. In this case, under the action of a restoring force of the second spring 8A, the main column 4 and the second piston 7A move upwards in the axial direction. Moreover, since the pressure in the storage chamber M is greater than the pressure in the lower chamber LM, the annular plate portion 92 of the elastic separator member 9 returns to its initial state to close the through hole 10. That is, the pressure storage type spray device A changes from the pressed state in FIG. 6 to the released state in FIG. 7. Meanwhile, under the action of the restoring force of the first spring 6, the first piston 5 moves downwards and applies a force to the air in the storage chamber M, so that the air flows faster into the fluid channel 41 through the fine hole 43 until the first piston 5 moves to the initial position where it is in contact with the columnar portion 91 of the elastic separator member 9 to close the fine hole 43. Thus, the pressure storage type spray device A is restored from the released state in FIG. 7 to the initial state in FIG. 3. On the other hand, in the releasing process, since the pressure in the liquid inlet portion 33 is greater than the pressure in the lower chamber LM, the steel ball B is jacked up, and the air or working liquid continuously flows into the lower chamber LM from the liquid inlet portion 33. As a result, the working liquid is stored in the lower chamber LM.

By repeatedly pressing and releasing the press type sprayer 1 as described above, the lower chamber LM will be filled with the working fluid.

Next, by pressing the press type sprayer 1, the main column 4 connected to the press type sprayer 1 and the second piston 7A connected to the main column 4 move downwards in the axial direction against the second spring 8A. At this time, since the steel ball B closes a connection port between the small diameter portion 32 and the liquid inlet portion 33, the working liquid in the lower chamber LM cannot be discharged from the bottom.

At this time, as the working liquid has the nature of incompressibility, when the working liquid in the lower chamber LM is extruded, a liquid pressure in the lower chamber LM is greater than a pressure in the storage chamber M. Therefore, as shown in FIG. 6, under the action of a pressure difference, the annular plate portion 92 of the elastic separator member 9 deforms upwards to open the through hole 10, and the working liquid in the lower chamber LM flows into the storage chamber M. Then, as the working liquid flows in, the first piston 5 moves upwards in the axial direction against the first spring 6. The fine hole 43 originally closed by a side surface of the first piston 5 is opened, so that the storage chamber M is in fluid communication with the fluid channel 41 in the main column 4. The working liquid located in the storage chamber M flows into the fluid channel through the fine hole 43. However, since the aperture of the through hole 10 is much larger than the aperture of the fine hole 43, the amount of the working liquid flowing from the lower chamber LM into the storage chamber M per unit time is greater than the amount of the working liquid flowing from the storage chamber M into the fluid channel 41 per unit time. From the entire pressing process, the volume of the storage chamber M increases, and the first piston 5 continues to move upwards in the axial direction against the first spring 6.

Meanwhile, due to the incompressibility of the working liquid, the steel ball B is always in a closed state, and the working liquid in the liquid inlet portion 33 cannot flow into the lower chamber LM.

When the press type sprayer 1 is pressed until the upper elastic mechanism displaces to a maximum compression position (for example, the compression deformation of the first spring 6 reaches a maximum elastic compression position or a lower end of the press type sprayer 1 resists against the cover component C), the press type sprayer 1 is released. In this case, under the action of the restoring force of the second spring 8A, the main column 4 and the second piston 7A move upwards in the axial direction, so that the pressure in the lower chamber LM becomes a negative pressure. Therefore, the annular plate portion 92 of the elastic separator member 9 returns to its initial state to close the through hole 10. That is, the pressure storage type spray device A changes from the pressed state in FIG. 6 to the released state in FIG. 7. Meanwhile, under the action of the restoring force of the first spring 6, the first piston 5 moves downwards and applies a force to the working liquid in the storage chamber M, so that the working liquid flows faster into the fluid channel 41 through the fine hole 43 until the first piston 5 moves to the initial position where it is in contact with the columnar portion 91 of the elastic separator member 9 to close the fine hole 43. Thus, the pressure storage type spray device A is restored from the released state in FIG. 7 to the initial state in FIG. 3. On the other hand, since the pressure in the lower chamber LM becomes the negative pressure, the steel ball B is jacked up, and the working liquid continuously flows into the lower chamber LM from the liquid inlet portion 33. As a result, the lower chamber LM is always filled with the working liquid.

In addition, as explained above, the aperture of the through hole 10 is much larger than the aperture of the fine hole 43. The amount of the working liquid flowing from the lower chamber LM into the storage chamber M per unit time is greater than the amount of the working liquid flowing from the storage chamber M into the fluid channel 41 per unit time. Therefore, by one or more pressings and releasings, the working liquid can be continuously sprayed to the outside from the storage chamber M through the fine hole 43 and the fluid channel 41. That is, based on the above structure, the effect of continuous spraying can be achieved through one or more pressings and releasings.

### Technical Effect of the First Implementation

A difference from the existing spray device is that in this implementation, the pressure storage type spray pump P1 is adopted, including the cylinder body 3, the main column 4, and the one-way valve type pressure storage unit. The one-way valve type pressure storage unit includes the first one-way valve mechanism and the upper elastic mechanism. The upper elastic mechanism includes the first piston 5 and the first spring 6. The first one-way valve mechanism includes the second piston 7A with through holes 10, the second spring 8A, and the elastic isolation member 9 for opening and closing the through holes 10.

By pressing the press type sprayer 1, the annular plate portion 92 of the elastic separator member 9 deforms upwards, and the through holes 10 are opened, so that the working liquid in the lower chamber LM of the cylinder body 3 flows into the storage chamber M between the first piston 5 and the second piston 7A. Meanwhile, the first piston 5 moves upwards under the action of the pressure of the working liquid flowing into the storage chamber M, and the volume of the storage chamber M continuously increases. Next, by releasing the press type sprayer 1, the annular plate portion 92 of the elastic separator member 9 returns to its initial state, and the through holes 10 are closed. Moreover, the first piston 5 moves downwards under the action of the first spring 6 in the compressed state, and the second piston 7A moves upwards under the action of the second spring 8A in the compressed state, thereby applying a pressure to the working liquid, so that the working liquid can flow into the fluid channel 41 through the fine holes 43 formed on the side wall of the main column 4 and be continuously sprayed to the outside from the fluid channel 41. In this way, by repeatedly pressing and releasing the press type sprayer 1, more and more working liquid is stored in the storage chamber M, which can prolong the spraying time and achieve the effect of continuous spraying.

That is, compared with the pressure storage type spray technology with a complex structure in the prior art, this implementation adopts the first one-way valve mechanism with a simple structure. By virtue of the characteristics of the first one-way valve mechanism, the effect of continuous spraying can be easily achieved by repeatedly pressing and releasing the sprayer.

In addition, compared with the existing non pressure storage type spray technology, this implementation can spray the working liquid to a target more uniformly. Specifically, for example, during cleaning of glass of a window, if a non pressure storage type spray device is used, different positions of the glass need to be sprayed separately. As a result, the amount of spraying at each position may be different and non-uniform due to changes in factors such as a pressure. On the contrary, when the pressure storage type technology of the present disclosure is used, the working liquid can cover the whole glass by only moving the spray device. Moreover, since the spraying process is not affected by the pressure, the working liquid can be uniformly sprayed to the whole glass as long as the spray device is moved at a constant speed.

### Second Implementation

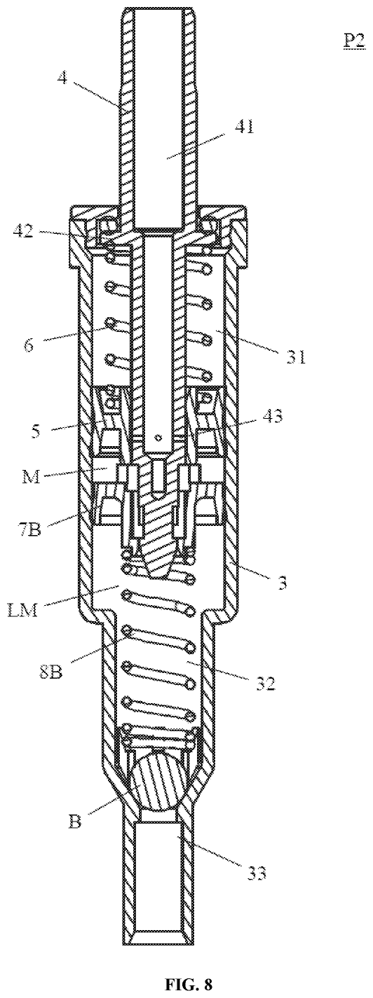

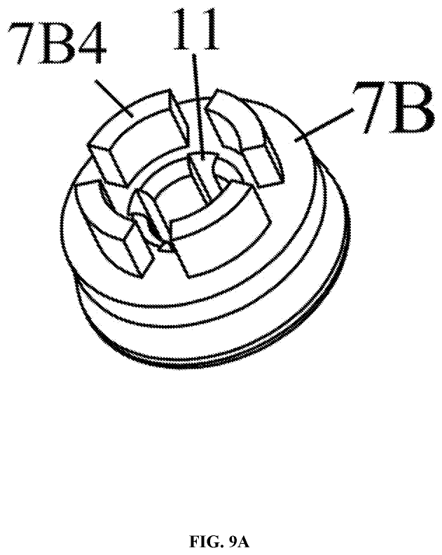

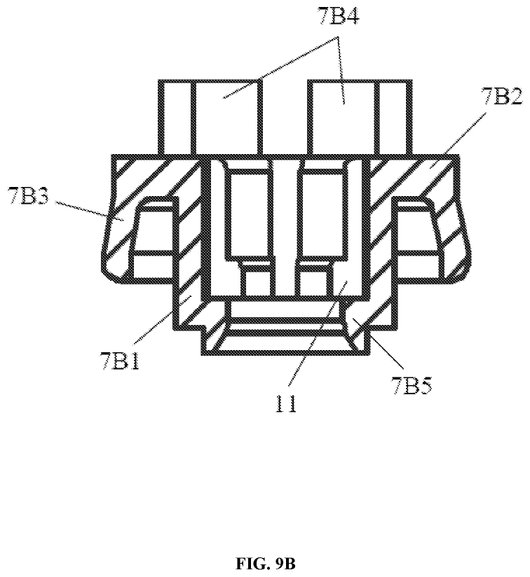

Afterwards, referring to FIG. 8, FIG. 9A, and FIG. 9B, a structure of a pressure storage type spray pump P2 of the second implementation of the present disclosure will be explained. It should be noted that this implementation is the same as the pressure storage type spray pump P1 of the first implementation in structure except a structure of a second one-way valve mechanism. Therefore, only the structure of the second one-way valve mechanism of this implementation will be explained here, and explanations of other parts will be omitted.

FIG. 8 shows a sectional view of a pressure storage type spray pump P2 according to a second implementation of the present disclosure. As shown in FIG. 8, the pressure storage type spray pump P2 includes a cylinder body 3, a main column 4, and a second one-way valve mechanism and an upper elastic mechanism that constitute a one-way valve type pressure storage unit. A difference from the first one-way valve mechanism of the first implementation is that the second one-way valve mechanism includes a second piston 7B and a second spring 8B.

Regarding the second piston 7B, FIG. 9A shows a three-dimensional view of the second piston 7B, and FIG. 9B shows a sectional view of the second piston 7B. As shown in FIG. 8, FIG. 9A, and FIG. 9B, the second piston 7B is a roughly annular component arranged between the cylinder body 3 and the main column 4. The second piston 7B is separated from the main column 4 and includes a hollow main body portion 7B1, an upper flange portion 7B2, a side flange portion 7B3, and a plurality of (four) stop portions 7B4. The upper flange portion 7B2 is formed at an upper end of the main body portion 7B1 and protrudes to a radial outer side. The side flange portion 7B3 is formed at a radial outer edge of the upper flange portion 7B2 and extends downwards in the axial direction. The plurality of stop portions 7B4 are formed on an upper surface of the upper flange portion 7B2 in the axial direction in an upwards protruding manner. In addition, as shown in FIG. 9A and FIG. 9B, an annular flange 7B5 that protrudes towards a radial inner side is formed at a lower end portion of the main body portion 7B1. The annular flange 7B5 is configured to tightly abut against an outer surface of the main column 4, which will be explained later. Moreover, a plurality of grooves 11 extending in the axial direction are formed in an inner surface of the main body portion 7B1. The plurality of grooves 11 are configured to allow air or working liquid to flow into the storage chamber M. In a state that the second piston 7B is arranged between the cylinder body 3 and the main column 4, the annular flange 7B5 of the main body portion 7B1 seamlessly and tightly abuts against an outer side surface of the main column 4 in the radial direction to cut off the fluid communication between the storage chamber M and the lower chamber LM, and the side flange portion 7B3 seamlessly and tightly abuts against an inner wall surface of the cylinder body 3 in the radial direction.

Regarding the second spring 8B, as shown in FIG. 8, the second spring 8B is arranged in the axial direction, with one end connected to an end portion of the main column 4 and the other end connected to an end portion of the cylinder body 3.

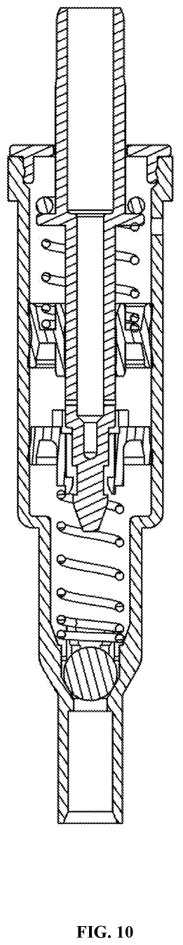

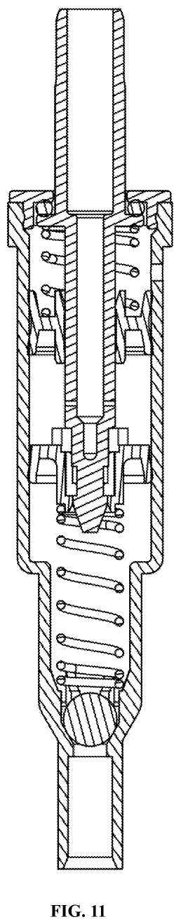

Then, based on the above structure, referring to FIG. 8, FIG. 10, and FIG. 11, the working principle of the second one-way valve mechanism of this implementation will be described in detail. To avoid repeated explanations, only the working liquid will be explained.

FIG. 8 shows a sectional view of the pressure storage type spray pump P2 in an initial state. In the initial state, the first piston 5 is in contact with the stop portion 7B4 of the second piston 7B to close the fine hole 43, so that the storage chamber M and the fluid channel 41 of the main column 4 are in a disconnected state.

Firstly, by pressing the press type sprayer 1, the main column 4 connected to the press type sprayer 1 moves downwards in the axial direction against the second spring 8B. At this time, since the steel ball B closes a connection port between the small diameter portion 32 and the liquid inlet portion 33, the working liquid in the lower chamber LM cannot be discharged from the bottom.

At this time, meanwhile, since the main column 4 moves downwards relative to the second piston 7B, the annular flange 7B5 of the second piston 7B and the outer side surface of the main column 4 which originally tightly abut against each other are separated, so that a space is generated between the second piston 7B and the main column 4. In this way, the working liquid in the lower chamber LM passes through the space and flows into the storage chamber M along the plurality of grooves 11 formed on the inner surface of the second piston 7B. Then, as the working liquid flows in, the first piston 5 moves upwards in the axial direction against the first spring 6. The fine hole 43 originally closed by a side surface of the first piston 5 is opened, so that the storage chamber M is in fluid communication with the fluid channel 41 in the main column 4. The working liquid located in the storage chamber M flows into the fluid channel through the fine hole 43. However, since the aperture of the through hole 10 is much larger than the aperture of the fine hole 43, the amount of the working liquid flowing from the lower chamber LM into the storage chamber M per unit time is greater than the amount of the working liquid flowing from the storage chamber M into the fluid channel 41 per unit time. From the entire pressing process, the volume of the storage chamber M increases, and the first piston 5 continues to move upwards in the axial direction against the first spring 6.

Meanwhile, due to the incompressibility of the working liquid, the steel ball B is always in a closed state, and the working liquid in the liquid inlet 33 cannot flow into the lower chamber LM.

When the press type sprayer 1 is pressed until the upper elastic mechanism displaces to a maximum compression position (for example, the compression deformation of the first spring 6 reaches a maximum elastic compression position or a lower end of the press type sprayer 1 resists against the cover component C), the press type sprayer 1 is released. At this time, under the action of the second spring 8B, the main column 4 moves upwards in the axial direction, and the annular flange 7B5 of the second piston 7B and the outer side surface of the main column 4 seamlessly and tightly abut against each other again, and the space therebetween disappears. The working liquid in the lower chamber LM cannot flow into the storage chamber M. That is, the pressure storage type spray device A changes from the pressed state in FIG. 10 to the released state in FIG. 11. Meanwhile, under the action of the restoring force of the first spring 6, the first piston 5 moves downwards and applies a force to the working liquid in the storage chamber M, so that the working liquid flows faster into the fluid channel 41 through the fine hole 43 until the first piston 5 moves to the initial position where it resists against the stop portion 7B4 of the second piston 7B to close the fine hole 43. Thus, the pressure storage type spray pump P2 is restored from the released state in FIG. 11 to the initial state in FIG. 8. On the other hand, since the space between the main column 4 and the second piston 7B disappears, the pressure in the lower chamber LM becomes the negative pressure, the steel ball B is jacked up, and the working liquid continuously flows into the lower chamber LM from the liquid inlet portion 33. As a result, the lower chamber LM is always filled with the working liquid.

In addition, as explained above, the aperture of the through hole 10 is much larger than the aperture of the fine hole 43. The amount of the working liquid flowing from the lower chamber LM into the storage chamber M per unit time is greater than the amount of the working liquid flowing from the storage chamber M into the fluid channel 41 per unit time. Therefore, by one or more pressings and releasings, the working liquid can be continuously sprayed to the outside from the storage chamber M through the fine hole 43 and the fluid channel 41. That is, based on the above structure, the effect of continuous spraying can be achieved through one or more pressings and releasings.

### Technical Effect of the Second Implementation

In this implementation, the one-way valve mechanism with another simple structure is used, which can also achieve the same technical effects as those in the first implementation.

### Third Implementation

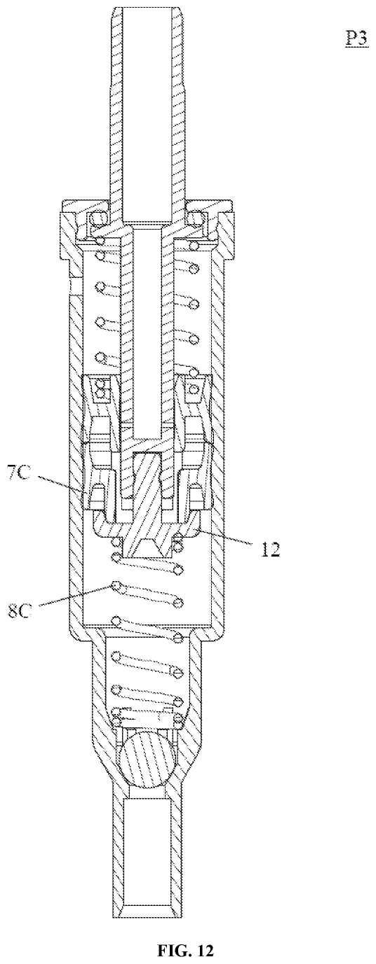

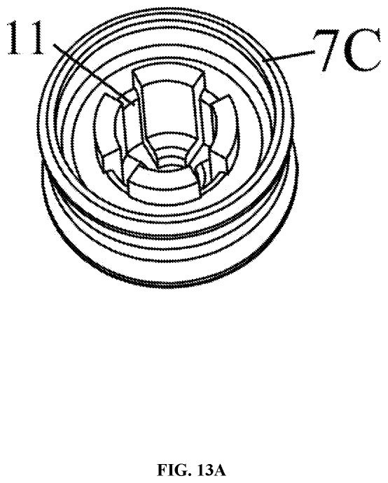

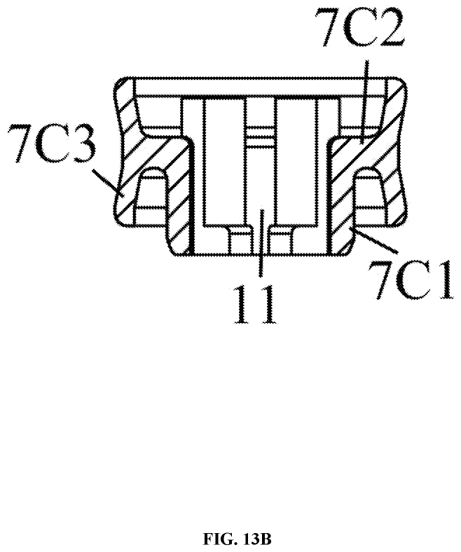

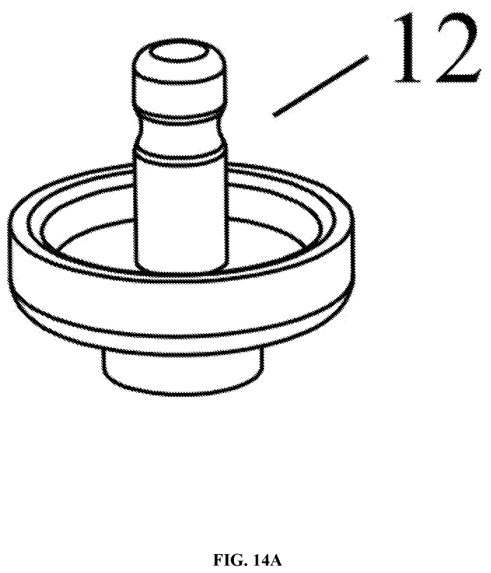

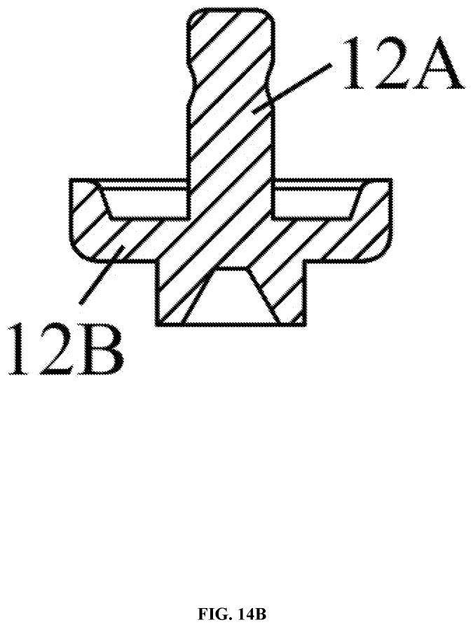

Afterwards, referring to FIG. 12, FIG. 13A, FIG. 13B, and FIG. 14, a structure of a pressure storage type spray pump P3 of the third implementation of the present disclosure will be explained. It should be noted that this implementation is the same as the pressure storage type spray pump P1 of the first implementation and the pressure storage type spray pump P2 of the second implementation in structure except a structure of a third one-way valve mechanism. Therefore, only the structure of the third one-way valve mechanism of this implementation will be explained here, and explanations of other parts will be omitted.

FIG. 12 shows a sectional view of a pressure storage type spray pump P3 according to a third implementation of the present disclosure. As shown in FIG. 12, the pressure storage type spray pump P3 includes a cylinder body 3, a main column 4, and a third one-way valve mechanism and an upper elastic mechanism that constitute a one-way valve type pressure storage unit. A difference from the first one-way valve mechanism of the first implementation and the second one-way valve mechanism of the second implementation is that the third one-way valve mechanism includes a second piston 7C, a second spring 8C, and an auxiliary column 12.

Regarding the second piston 7C, FIG. 13A shows a three-dimensional view of the second piston 7C, and FIG. 13B shows a sectional view of the second piston 7C. As shown in FIG. 12, FIG. 13A, and FIG. 13B, the second piston 7C is a roughly annular component arranged between the cylinder body 3 and the main column 4. The second piston 7B is separated from the main column 4 and includes a hollow main body portion 7C1, an upper flange portion 7C2, and a side flange portion 7C3. The upper flange portion 7C2 is formed at an upper end of the main body portion 7C1 and protrudes to a radial outer side. The side flange portion 7C3 is formed at a radial outer edge of the upper flange portion 7C2 and extends downwards in the axial direction. In addition, as shown in FIG. 13A and FIG. 13B, a plurality of grooves 11 extending in the axial direction are formed in an inner surface of the main body portion 7C1. The plurality of grooves 11 are configured to allow air or working liquid to flow into the storage chamber M. In a state that the second piston 7C is arranged between the cylinder body 3 and the main column 4, a lower end portion of the main body portion 7B1 seamlessly and tightly abuts against an aftermentioned auxiliary column 12 in the axial direction to cut off the fluid communication between the storage chamber M and the lower chamber LM, and the side flange portion 7C3 seamlessly and tightly abuts against an inner wall surface of the cylinder body 3 in the radial direction.

Regarding the second spring 8C, as shown in FIG. 12, the second spring 8C is arranged in the axial direction, with one end connected to the auxiliary column 12 and the other end connected to an end portion of the cylinder body 3.

Regarding the auxiliary column 12, FIG. 14A shows a three-dimensional diagram of the auxiliary column 12, and FIG. 14B shows a sectional view of the auxiliary column 12. As shown in FIG. 14A and FIG. 14B, the auxiliary column 12 includes an axial embedding portion 12A and a radial flange portion 12B. The axial embedding portion 12A is a part that is embedded into a recess shown in FIG. 12 and formed in an end portion of the main column 4 in the axial direction. The radial flange portion 12B is a part that is configured to seamlessly and tightly abut against a lower end portion of the main body portion 7C1 of the second piston 7C in the axial direction.

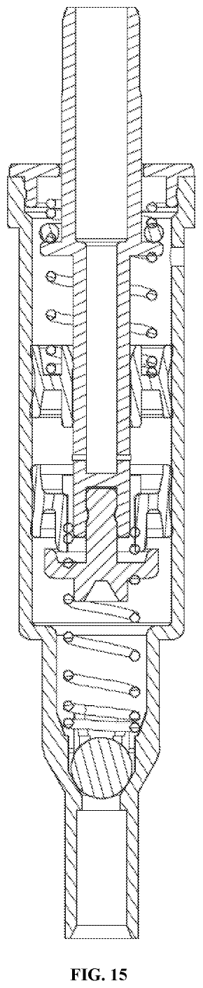

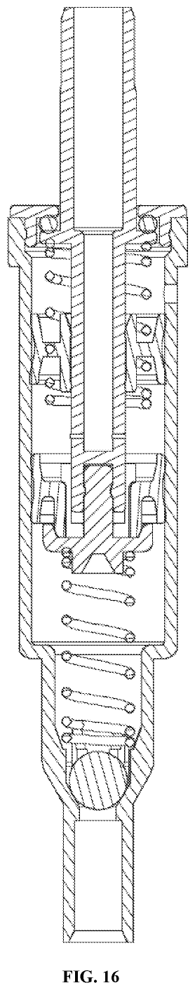

Then, based on the above structure, referring to FIG. 12, FIG. 15, and FIG. 16, the working principle of the third one-way valve mechanism of this implementation will be described in detail. To avoid repeated explanations, only the working liquid will be explained.

FIG. 12 shows a sectional view of the pressure storage type spray pump P3 in an initial state. In the initial state, the first piston 5 is in contact with the upper flange portion 7C2 of the second piston 7C to close the fine hole 43, so that the storage chamber M and the fluid channel 41 of the main column 4 are in a disconnected state. In addition, the auxiliary column 12 is fixed to the main column 4 in a manner of being embedded into the recess of the main column 4.

Firstly, by pressing the press type sprayer 1, the main column 4 connected to the press type sprayer 1 and the auxiliary column 12 fixed to the main column 4 move downwards in the axial direction against the second spring 8C. At this time, since the steel ball B closes a connection port between the small diameter portion 32 and the liquid inlet portion 33, the working liquid in the lower chamber LM cannot be discharged from the bottom.

At this time, meanwhile, since the main column 4 and the auxiliary column 12 move downwards relative to the second piston 7C, the lower end portion of the main body portion 7C1 of the second piston 7 and the radial flange portion 12B of the auxiliary column 12 which originally tightly abut against each other are separated, so that a space is generated between the second piston 7C and the auxiliary column 12. In this way, the working liquid in the lower chamber LM passes through the space and flows into the storage chamber M along the plurality of grooves 11 formed on the inner surface of the second piston 7B. Then, as the working liquid flows in, the first piston 5 moves upwards in the axial direction against the first spring 6. The fine hole 43 originally closed by a side surface of the first piston 5 is opened, so that the storage chamber M is in fluid communication with the fluid channel 41 in the main column 4. The working liquid located in the storage chamber M flows into the fluid channel through the fine hole 43. However, since the aperture of the through hole 10 is much larger than the aperture of the fine hole 43, the amount of the working liquid flowing from the lower chamber LM into the storage chamber M per unit time is greater than the amount of the working liquid flowing from the storage chamber M into the fluid channel 41 per unit time. From the entire pressing process, the volume of the storage chamber M increases, and the first piston 5 continues to move upwards in the axial direction against the first spring 6.

Meanwhile, due to the incompressibility of the working liquid, the steel ball B is always in a closed state, and the working liquid in the liquid inlet 33 cannot flow into the lower chamber LM.

When the press type sprayer 1 is pressed until the upper elastic mechanism displaces to a maximum compression position (for example, the compression deformation of the first spring 6 reaches a maximum elastic compression position or a lower end of the press type sprayer 1 resists against the cover component C), the press type sprayer 1 is released. At this time, under the action of the second spring 8C, the main column 4 and the auxiliary column 12 move upwards in the axial direction, and the lower end portion of the main body portion 7C1 of the second piston 7 and the radial flange portion 12B of the auxiliary column 12 seamlessly and tightly abut against each other again, and the space therebetween disappears. The working liquid in the lower chamber LM cannot flow into the storage chamber M. That is, the pressure storage type spray device A changes from the pressed state in FIG. 15 to the released state in FIG. 16. Meanwhile, under the action of the restoring force of the first spring 6, the first piston 5 moves downwards and applies a force to the working liquid in the storage chamber M, so that the working liquid flows faster into the fluid channel 41 through the fine hole 43 until the first piston 5 moves to the initial position where it resists against the stop portion 7B4 of the second piston 7B to close the fine hole 43. Thus, the pressure storage type spray pump P3 is restored from the released state in FIG. 16 to the initial state in FIG. 12. On the other hand, since the space between the main column 4 and the second piston 7B disappears, the pressure in the lower chamber LM becomes the negative pressure, the steel ball B is jacked up, and the working liquid continuously flows into the lower chamber LM from the liquid inlet portion 33. As a result, the lower chamber LM is always filled with the working liquid.

In addition, as explained above, the aperture of the through hole 10 is much larger than the aperture of the fine hole 43. The amount of the working liquid flowing from the lower chamber LM into the storage chamber M per unit time is greater than the amount of the working liquid flowing from the storage chamber M into the fluid channel 41 per unit time. Therefore, by one or more pressings and releasings, the working liquid can be continuously sprayed to the outside from the storage chamber M through the fine hole 43 and the fluid channel 41. That is, based on the above structure, the effect of continuous spraying can be achieved through one or more pressings and releasings.

### Technical Effect of the Third Implementation

In this implementation, the one-way valve mechanism with still another simple structure is used, which can also achieve the same technical effects as those in the first implementation and the second implementation.

### Other Implementations

The pressure storage type spray pumps and the pressure storage type spray devices of the first embodiment to the third embodiment of the present disclosure have been described above. However, the structure of the present disclosure is not limited to the above implementations, and can also be further improved on the basis of the above implementations.

For example, in the first implementation, preferably, a plurality of through holes are circumferentially formed at equal intervals in the second piston. Thus, it is possible to make the air or working liquid in the lower chamber LM flow more uniformly into the storage chamber M, maintain a uniform force on the second piston and the annular plate portion of the elastic separator member, and avoid the skewness of the elastic separator member.

For example, in the second and third implementations mentioned above, preferably, a plurality of the grooves are circumferentially formed at equal intervals in the inner surface of the second piston. Thus, it is possible to make the air or working liquid in the lower chamber LM flow more uniformly into the storage chamber M and maintain a uniform force on the second piston.

For example, in the first to third implementations mentioned above, preferably, a plurality of fine holes are circumferentially formed at equal intervals on the side wall of the main column 4. Therefore, the air or working liquid in the storage chamber M can flow uniformly into the fluid channel 41 in the whole circumferential direction of the main column 4, which can further improve the effect of spraying.

In addition, within the scope of the present disclosure, the various implementations can be freely combined, or can be appropriately transformed or omitted.

### DESCRIPTION OF REFERENCE NUMERALS

A: pressure storage type spray device
P1, P2, P3: pressure storage type spray pump
1: press type sprayer
2: suction pipe
C: cover component
C1: thread
3: cylinder body
31: large diameter portion
32: small diameter portion
33: liquid inlet portion
B: steel ball
4: main column
41: fluid channel
42: flange portion
43: fine hole
5: first piston
6: first spring
7A, 7B, 7C: second piston
8A, 8B, 8C: second spring
9: elastic separator member
91: columnar portion
92: annular plate portion
10: through hole
7A1, 7B1, 7C1: main body portion
7A2, 7B2, 7C2: upper flange portion
7A3, 7B3, 7C3: side flange portion
7B4: stop portion
7B5: annular flange
11: groove
12: auxiliary column
12A: axial embedding portion
12B: radial flange portion
M: storage chamber
LM: lower chamber

What is claimed is:

1. A pressure storage type spray pump (P1, P2, P3), comprising a main column (4) and a cylinder body (3), wherein a fluid channel (41) extending in an axial direction is formed inside the main column (4), and the cylinder body (3) accommodates a working liquid and is inserted with the main column (4);
the spray pump further comprises a one-way valve mechanism, a storage chamber (M), and an upper elastic mechanism which are axially arranged between the main column (4) and the cylinder body (3);
the storage chamber (M) is formed between the one-way valve mechanism and the upper elastic mechanism;
the one-way valve mechanism is configured to be opened only when the main column (4) is pressed and only allow the working liquid to flow from the cylinder body (3) into the storage chamber (M);
the upper elastic mechanism is configured to be capable of displacing, relative to the main column (4), between an initial position and a maximum compression position; the upper elastic mechanism displaces towards the maximum compression position when the main column (4) is pressed, so that the storage chamber (M) is in fluid communication with the fluid channel (41); and the upper elastic mechanism displaces towards the initial position when the main column (4) is released.

2. The pressure storage type spray pump (P1) according to claim 1, wherein
the one-way valve mechanism comprises:
a second piston (7A), wherein the second piston (7A) and the upper elastic mechanism are arranged in the axial direction through the storage chamber (M) and are fixed to the main column (4), and a through hole (10) that penetrates through the second piston (7A) in the axial direction is formed in the second piston (7A);
a second elastic body (8A), wherein the elastic body (8A) is connected to the main column (4) and the cylinder body (3) in the axial direction, or is connected to the second piston (7A) and the cylinder body (3) in the axial direction; and
an elastic separator member (9), wherein the elastic separator member (9) is configured to cover the through hole (10); and
by pressing the main column (4), the elastic separator member (9) deforms to open the through hole (10).

3. The pressure storage type spray pump (P1) according to claim 2, wherein
a plurality of the through holes (10) are circumferentially formed at equal intervals in the second piston (7A).

4. The pressure storage type spray pump (P2) according to claim 1, wherein
the one-way valve mechanism comprises:
an annular second piston (7B), wherein the second piston (7B) and the upper elastic mechanism are arranged in the axial direction through the storage chamber (M); and
a second spring (8B), wherein the second spring (8B) is connected to the main column (4) and the cylinder body (3) in the axial direction;
a groove (11) extending in the axial direction is formed in an inner surface of the second piston (7B);
an annular flange (7B5) protruding towards a radial inner side is formed at one end of the second piston (7B) away from the storage chamber (M), and the annular flange (7B5) seamlessly and tightly abuts against an outer surface of the main column (4) in a radial direction of the main column (4); and
by pressing the main column (4), the annular flange (7B5) is separated from the outer surface of the main column (4), and the cylinder body (3) is in fluid communication with the storage chamber (M) through the groove (11).

5. The pressure storage type spray pump (P2) according to claim 4, wherein
a plurality of the grooves (11) are circumferentially formed at equal intervals in the inner surface of the second piston (7B).

6. The pressure storage type spray pump (P3) according to claim 1, wherein
the one-way valve mechanism comprises:
an annular second piston (7C), wherein the second piston (7C) and the upper elastic mechanism are arranged in the axial direction through the storage chamber (M);
an auxiliary column (12), wherein the auxiliary column (12) is fixedly connected to one end portion of the main column (4) close to the second piston (7C), and the auxiliary column (12) seamlessly and tightly abuts against the second piston (7C) in the axial direction; and
a second spring (8C), wherein the second spring (8C) is connected to the auxiliary column (12) and the cylinder body (3) in the axial direction;
a groove (11) extending in the axial direction is formed in an inner surface of the second piston (7C); and
by pressing the main column (4), the second piston (7C) is separated from the auxiliary column (12), and the cylinder body (3) is in fluid communication with the storage chamber (M) through the groove (11).

7. The pressure storage type spray pump (P3) according to claim 6, wherein
a plurality of the grooves are circumferentially formed at equal intervals in the inner surface of the second piston.

8. The pressure storage type spray pump (P1, P2, P3) according to claim 1, wherein
a fine hole (43) communicated with the fluid channel (41) is formed in a side wall of the main column (4);
when the upper elastic mechanism is at the initial position, the fine hole (43) is closed by the upper elastic mechanism; and
by pressing the main column (4), the fine hole (43) is opened, so that the storage chamber (M) is in fluid communication with the fluid channel (41).

9. The pressure storage type spray pump (P1, P2, P3) according to claim 8, wherein
a plurality of fine holes (43) are circumferentially formed at equal intervals on the side wall of the main column (4).

10. The pressure storage type spray pump (P1, P2, P3) according to claim 2, wherein
a stop portion (7B4) is formed on one surface of the second piston (7A, 7B, 7C) close to the upper elastic mechanism, and the stop portion (7B4) is configured to receive the upper elastic mechanism and cause the upper elastic mechanism to be located at the initial position.

11. The pressure storage type spray pump (P1, P2, P3) according to claim 2, wherein
the upper elastic mechanism comprises:
a first piston (5), wherein the first piston (5) is arranged between the main column (4) and the cylinder body (3), and the first piston (5) and the second piston (7A, 7B, 7C) face each other in the axial direction through the storage chamber (M); and
a first elastic body (6), wherein the first elastic body (6) is connected to the main column (4) and the first piston (5) in the axial direction.

12. The pressure storage type spray pump (P1, P2, P3) according to claim 8, wherein
the upper elastic mechanism comprises:
a first piston (5), wherein the first piston (5) is arranged between the main column (4) and the cylinder body (3), and the first piston (5) and the second piston (7A, 7B, 7C) face each other in the axial direction through the storage chamber (M); and
a first elastic body (6), wherein the first elastic body (6) is connected to the main column (4) and the first piston (5) in the axial direction.

13. The pressure storage type spray pump (P1, P2, P3) according to claim 10, wherein
the upper elastic mechanism comprises:
a first piston (5), wherein the first piston (5) is arranged between the main column (4) and the cylinder body (3), and the first piston (5) and the second piston (7A, 7B, 7C) face each other in the axial direction through the storage chamber (M); and
a first elastic body (6), wherein the first elastic body (6) is connected to the main column (4) and the first piston (5) in the axial direction.

14. A pressure storage type spray device (A), comprising
the pressure storage type spray pump (P1, P2, P3) according to claim 1; and
a press type sprayer (1), wherein the press type sprayer (1) cooperates with the pressure storage type spray pump (P1, P2, P3) to apply a force to the main column (4) of the pressure storage type spray pump (P1, P2, P3) in the axial direction.

15. The pressure storage type spray pump (A) according to claim 14,
further comprising a cover component (C), wherein the cover component (C) is configured to accommodate the cylinder body (3) inserted with the main column (4).

16. The pressure storage type spray pump (A) according to claim 15,
wherein the cover component (C) is a screw cap with a thread (C1) on an inner wall.
